(19) United States
(12) Patent Application Publication
(10) Pub. No.: US 2005/0202139 A1
(43) Pub. Date: Sep. 15, 2005

(54) Recovery of isoflavones from aqueous mixtures using zeolites or molecular sieves

(76) Inventors: David Richard Corbin, West Chester, PA (US); Vidya Pai, Wilmington, DE (US); Stuart M. Thomas, Wilmington, DE (US)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 10/983,123

(22) Filed: Nov. 5, 2004

Related U.S. Application Data
(60) Provisional application No. 60/517,796, filed on Nov. 5, 2003.

(51) Int. Cl. A23P 1/00

(52) U.S. Cl. 426/489

(57) ABSTRACT

The present invention provides a process using a zeolite or molecular sieve for recovering isoflavones from aqueous mixtures, such as soy whey and other biological waste products. A zeolite, such as a large pore, hydrophobic zeolite, has a significantly higher affinity for isoflavones than conventional polymeric adsorbents, and has essentially no affinity for the undesired oligosaccharides raffinose and stachyose.

### FIELD OF THE INVENTION

The present invention relates to a process for recovering isoflavones from aqueous mixtures. More specifically, the invention involves the use of large pore, hydrophobic zeolites or molecular sieves to recover isoflavones from soy whey and other biological waste products.

### BACKGROUND OF THE INVENTION

Isoflavones are colorless, crystalline ketones found primarily in leguminous plants. One of the most important sources of isoflavones is the soybean, which contains twelve distinct isoflavones: genistein, genistin, 6″-O-malonylgenistin, 6″-O-acetylgenistin, daidzein, daidzin, 6″-O-malonyldaidzin, 6″-O-acetyldaidzin, glycitein, glycitin, 6″-O-malonylglycitin, 6″-O-acetylglycitin (Kudou, Agric. Biol. Chem. 55, 2227-2233 1991). These soybean isoflavones share the generic structure shown below:

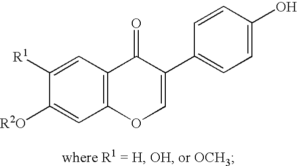

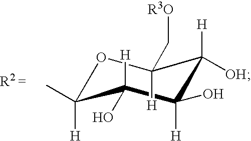

Dietary isoflavones are believed to have health benefits. For example, they are believed to be responsible for the cholesterol-lowering effect of soy products and may help prevent breast cancer. Moreover, isoflavones are believed to ameliorate menopausal symptoms. U.S. Pat. No. 5,972,995 teaches the treatment of cystic fibrosis patients by administering isoflavones capable to stimulate chloride transport.

Soy protein isolates are typically prepared from defatted soy meal. Proteins and soluble carbohydrates are extracted into aqueous solution (pH 7-10). The insoluble residue is mostly carbohydrate and is removed by centrifugation. The protein is precipitated from solution as curd at its isoelectric point (about pH 4.5), further purified, neutralized, and dried. The liquid remaining after the protein has been isolated is referred to as whey and contains mainly soluble carbohydrates. Most of the isoflavones are retrieved with the protein curd.

Isoflavones also exist at the parts per million (ppm) level in the whey. Given the high value of isoflavones, a simple, efficient and selective process for recovering them from soy whey would be highly desirable. Soy whey also contains carbohydrates, including oligosaccharides such as raffinose and stachyose, proteins, salts and other bioactives. The method must be able to selectively recover isoflavones from these other compounds (particularly from the undesired oligosaccharides raffinose and stachyose) which are not readily digested in the human gastrointestinal tract. Currently, the soy whey is treated as waste, resulting in significant disposal costs. Other waste products, such as paper mill wastes, have been reported to contain isoflavones [Science News, 159: 328 (2001)]. Recovery of isoflavones from these wastes would also be desirable.

A process for separating specific isoflavone fractions from soy whey and soy molasses feed streams is described in U.S. Pat. Nos. 6,033,714; 5,792,503; and 5,702, 752. “Soy molasses” (also referred to as “soy solubles”) is obtained when vacuum distillation removes the ethanol from an aqueous ethanol extract of defatted soy meal. The feed stream is heated to a temperature chosen according to the specific solubility of the desired isoflavone fraction. The stream is then passed through an ultrafiltration membrane, which allows isoflavone molecules below a cutoff molecular weight to permeate. The permeate then may be concentrated using a reverse osmosis membrane. The concentrated stream is then put through a resin adsorption process using at least one liquid chromatographic column to further separate the fractions.

“Amberlite” XAD4 polymeric adsorbent (Rohm and Haas, Philadelphia, Pa.) is described in U.S. Pat. No. 6,033,714 as particularly attractive for the chromatography columns. XAD-4 has been described as a hydrophobic, crosslinked styrene divinylbenzene polymer [Kunin, Polym. Sci. and Eng., 17(1), 58-62 (1977)]. XAD4 has good stability and its characteristic pore size distribution makes it suitable for adsorption of organic substances of relatively low molecular weight. As disclosed in U.S. Pat. No. 6,033,714, however, other adsorptive resins may be used in the chromatography columns.

In another method, U.S. Pat. No. 6,261,565 describes a composition, enriched in isoflavones, that is obtained by fractionating a plant source high in isoflavones, including soy molasses and soy whey. In this process, the aqueous solution containing the isoflavones is passed through an ultrafiltration membrane and then fed through a resin column to isolate the isoflavones. KP Patent No. 2000/055,133 describes a method for the separation of isoflavones from bean curd waste solution using an acrylic or polyaromatic resin.

In all these disclosures, a polymeric adsorbent is used to recover the isoflavones from the aqueous mixtures. However, in order to recover the low level of isoflavones in biological waste products such as soy whey more effectively, an adsorbent with a higher affinity for isoflavones is required.

Zeolites are high capacity, selective adsorbents that have been widely used for separating a variety of chemical compounds. Zeolites can be generically described as complex aluminosilicates characterized by three-dimensional framework structures enclosing cavities occupied by ions and water molecules, all of which can move with significant freedom within the zeolite matrix (Meier et al., Atlas of Zeolite Structure Types, Elsevier, 2001). In commercially useful zeolites, the water molecules can be removed from or replaced within the framework structures without destroying the zeolite's geometry.

Zeolites have been widely used as bulk adsorbents and as chromatography supports for the separation of a variety of substances including gases, hydrocarbons, alcohols and carbohydrates. For example, the use of zeolites for the separation of simple sugars is described by Ho et al [Ind. Eng. Chem. Res. 26: 1407 (1987)], Sherman et al [Stud. Surf. Sci. Catal. 28: 1025 (1980)], and Buttersack et al [J. Phys. Chem. 97: 11861 (1993)]. A process for separating monosaccharides using zeolite adsorbents is described in U.S. Pat. No. 4,4405,377. The use of hydrophobic zeolites for the selective adsorption of oligosaccharides such as raffinose and stachyose is described by Buttersack [Langmuir 12: 3101 (1996)]. The use of zeolites as adsorbents for bulk separations is reviewed by Jasra et al [Separation Science and Technology 23: 945 (1988)]. However, there have been no reports of the use of zeolites as selective adsorbents for isoflavones.

The need exists for a simple, economical process to selectively recover high value isoflavones from biological waste products such as soy whey. To satisfy this need, a selective adsorbent for isoflavones with a significantly higher affinity than conventional polymeric adsorbents is required. Additionally, the adsorbent must have essentially no affinity for the undesired oligosaccharides raffinose and stachyose.

### SUMMARY OF THE INVENTION

One embodiment of the invention is a process for selectively recovering isoflavones form an aqueous mixture by (a) contacting a large pore, hydrophobic zeolite or molecular sieve with an aqueous mixture; (b) separating the zeolite or molecular sieve from the aqueous mixture; and (c) releasing the adsorbed isoflavones from the zeolite or molecular sieve by contacting with an organic solvent.

A further embodiment of the invention is a method of using a large pore, hydrophobic zeolite or molecular sieve to selectively recover isoflavones from an aqueous mixture.

Embodiments also include using an alcohol such as methanol, ethanol, or isopropanol as preferred organic solvents, with ethanol as the most preferred choice. The zeolite or molecular sieve is preferably used in a batch reactor or column.

Some or all of the steps of the method of the invention may be repeated one or more times to complete the recovery of the isoflavones from the aqueous mixture to the desired degree.

It has been found that the method of this invention provides an efficient, economical way to recover isoflavones from an aqueous mixture.

### BRIEF DESCRIPTION OF THE FIGURES

FIG. 1 shows the adsorption isotherms for the adsorption of isoflavones from soy whey onto various zeolites and organic polymer supports. The x-axis is the equilibrium concentration of the isoflavones in solution in mg/L. The y-axis is the amount of isoflavones adsorbed onto the adsorbents in mg/g dry weight of adsorbent.

FIG. 2 shows the isotherms for the adsorption of isoflavones from soy whey onto several beta zeolites. The x-axis is the equilibrium concentration of the isoflavones in solution in mg/L. The y-axis is the amount of isoflavones adsorbed onto the zeolite adsorbents in mg/g dry weight of zeolite.

FIG. 3 shows the adsorption isotherms for the adsorption of isoflavones from soy whey onto free-flowing powders and pelleted forms of beta zeolites. The x-axis is the equilibrium concentration of the isoflavones in solution in mg/L. The y-axis is the amount of isoflavones adsorbed onto the zeolite adsorbents in mg/g dry weight of zeolite.

### DETAILED DESCRIPTION OF THE INVENTION

This invention relates to the selective recovery of isoflavones from aqueous mixtures using zeolites or molecular sieves. The process involves contacting the aqueous mixture containing the isoflavones with a large pore, hydrophobic zeolite or molecular sieve adsorbent. These zeolites or molecular sieves have a significantly higher affinity for isoflavones than conventional polymeric adsorbents. After contact, the aqueous mixture is removed and the zeolite or molecular sieve adsorbent may be washed with water to remove unadsorbed, soluble materials. The isoflavones are recovered by contacting the zeolite or molecular sieve adsorbent with an organic solvent. Additionally, it was found that the preferred zeolites have essentially no affinity for the undesired oligosaccharides raffinose and stachyose.

Abbreviations as used herein may be defined as shown in the following list:
BEA refers to zeolite beta.
C is equilibrium isoflavone concentration in units of mg/L.
CHA refers to the zeolite structure type Chabazite.
ERI refers to the zeolite structure type Erionite.
EtOAc is ethyl acetate.
FAU refers to the zeolite faujasite.
h is hour or hours.
HPLC refers to the separation and analysis technique, high performance liquid chromatography.
IC is ion chromatography.
K and n are empirical constants calculated from fitting the adsorption data to the Power Law equation.
KDa means kilodaltons.
KFI refers to the zeolite structure type ZK-5.
LTA refers to the zeolite structure type Linde Type A.
LTL refers to the zeolite structure type Linde Type L.
MEHQ is p-methoxyphenol.
mM is a unit of concentration meaning millimoles per liter.
MEL refers to the zeolite structure type ZSM-11.
MFI refers to the zeolite structure type ZSM-5.
MOR refers to the zeolite mordenite.
nm is nanometers.
ppm is a unit of concentration meaning parts per million.
PS-DVB refers to a poly(styrene-co-divinylbenzene) adsorbent.
MW is molecular weight.
q is the loading of isoflavone on the adsorbent in mg/g of dry adsorbent.
Qmax and B are empirical constants calculated from fitting the adsorption data to a Langmuir adsorption isotherm.
R is the correlation coefficient of a linear regression fit of the data.
rpm is revolutions per minute.
RHO refers to the zeolite structure type Rho.
SPA refers to a specially synthesized polymeric adsorbent prepared by suspension polymerization of methacrylic acid, styrene, and ethylene glycol dimethacrylate.
TC refers to a thermocouple used to monitor temperature.
TON refers to the zeolite structure type Theta-1.
XAD-4 refers to a commercial, polymeric resin, Amberlite®, a hydrophobic, cross-linked styrene/divinylbenzene polymer.

The starting material in the process is an aqueous mixture that contains isoflavones including, but not limited to, biological waste products such as soy whey, wheys from a variety of vegetable protein sources, or paper mill wastes. The aqueous mixture can be in the form of a homogeneous solution, a heterogeneous suspension, or an emulsion. The term “isoflavones” will herein refer to a class of colorless, crystalline ketones such as are found for example in leguminous plants. Certain of these isoflavones have been found to have numerous health benefits. These include, but are not limited to, the soy isoflavones: genistein, genistin, 6″-O-malonylgenistin, 6″-O-acetylgenistin, daidzein, daidzin, 6″-O-malonyldaidzin, 6″-O-acetyidaidzin, glycitein, glycitin, 6″-O -malonylglycitin, 6″-O-acetylglycitin.

The preferred starting material for this invention is soy whey. Soy whey is a by-product of soybean processing, which is reviewed in Soybeans—Chemistry, Technology, and Utilization, by KeShun Liu [Chapman & Hall, New York, 1997]. The processing of soybeans may be done in many well-known ways. For example, soy protein isolates are typically prepared from defatted soy meal. Proteins and soluble carbohydrates are extracted into aqueous solution (pH 7-10). The insoluble residue is mostly carbohydrate and is removed by centrifugation. The protein is precipitated from solution as curd at its isoelectric point (about pH 4.5). The liquid remaining after the protein has been isolated is referred to as the soy whey, which is typically treated as waste. The whey contains isoflavones at the parts per million (ppm) level, as well as soluble carbohydrates. It is desirable to selectively recover the isoflavones from the undesired oligosaccharides raffinose and stachyose, which are not readily digested in the human gastrointestinal tract.

The aqueous mixture is treated to remove particulate matter by means including, but not limited to, filtration or centrifugation. For example, the aqueous mixture may be ultra-filtered through a 10 KDa hollow fiber module. Then the treated sample may be contacted with the calcined zeolite adsorbent in the form of a batch reactor, a fluidized bed reactor or a packed column. Separation methods such as these are known in the art. For example, the use of batch reactors and fluidized bed reactors is described in U.S. Pat. No. 4,483,980, and the use of adsorption resins in a packed column is described in U.S. Pat. No. 6,033,714, each of which is incorporated in its entirety as a part hereof for all purposes. Methods for calcining zeolites are known in the art [Shannon et al., J. Catal. 113: 367-382 (1988)]. One examplary method of calcining involves heating the zeolite in air at a rate of 1° C./minute to 400° C., holding for 10 minutes at 400° C., heating to 450° C. at a rate of 1° C./minute, holding for 10 minutes at 450° C., heating to 500° C. at a rate of 1° C./minute, holding at 500° C. for 5 hours, and then cooling to 110° C.

Zeolites can be generally represented by the following formula M_{2/n}O.•Al₂O₃.•xSiO₂.•yH₂O wherein M is a cation of valence n, x is greater than or equal to about 2, and y is a number determined by the porosity and the hydration state of the zeolite, generally from about 2 to about 8. In naturally occurring zeolites, M is principally represented by Na, Ca, K, Mg and Ba in proportions usually reflecting their approximate geochemical abundance. The cations M are loosely bound to the structure and can frequently be completely or partially replaced with other cations by conventional ion exchange.

The zeolite framework structure has corner-linked tetrahedra with Al or Si atoms at centers of the tetrahedra and oxygen atoms at the corners. Such tetrahedra are combined in a well-defined repeating structure comprising various combinations of 4-, 6-, 8-, 10-, and 12-membered rings. The resulting framework structure is a pore network of regular channels and cages that is useful for separation. Pore dimensions are determined by the geometry of the aluminosilicate tetrahedra forming the zeolite channels or cages, with nominal openings of about 0.26 nm for 6-member rings, about 0.40 nm for 8-member rings, about 0.55 nm for 10-member rings and about 0.74 nm for 12-member rings (these numbers assume ionic radii for oxygen). Zeolites with the largest pores, being 8-member rings, 10-member rings, and 12-member rings, are frequently considered small, medium and large pore zeolites, respectively. Pore dimensions are critical to the performance of these materials in catalytic and separation applications, since this characteristic determines whether molecules of certain size can enter and exit the zeolite framework. In practice, it has been observed that very slight decreases in ring dimensions can effectively hinder or block movement of particular molecular species through the zeolite structure.

The effective pore dimensions that control access to the interior of the zeolites are determined not only by the geometric dimensions of the tetrahedra forming the pore opening, but also by the presence or absence of ions in or near the pore. For example, in the case of zeolite type A, access can be restricted by monovalent ions, such as Na⁺ or K⁺, which are situated in or near 8-member ring openings as well as 6-member ring openings. Access can be enhanced by divalent ions, such as Ca²⁺, which are situated only in or near 6-member ring openings. Thus, the potassium and sodium salts of zeolite A exhibit effective pore openings of about 0.3 nm and about 0.4 nm respectively, whereas the calcium salt of zeolite A has an effective pore opening of about 0.5 nm. The presence or absence of ions in or near the pores, channels, and/or cages can also significantly modify the accessible pore volume of the zeolite for sorbing materials.

Representative examples of zeolites are (i) small pore zeolites such as NaA (LTA), CaA (LTA), Erionite (ERI), Rho (RHO), ZK-5 (KFI) and chabazite (CHA); (ii) medium pore zeolites such as ZSM-5 (MFI), ZSM-11 (MEL), ZSM-22 (TON), and ZSM-48; and (iii) large pore zeolites such as zeolite beta (BEA), faujasite (FAU), mordenite (MOR), zeolite L (LTL), NaX (FAU), NaY (FAU), DA-Y (FAU) and CaY (FAU). The letters in parentheses give the framework structure type of the zeolite.

The zeolites useful in this invention include large pore, hydrophobic zeolites, including, but not limited to, faujasites and beta zeolites, having a high silicon to aluminum ratio. The preferred zeolite adsorbent is zeolite beta. Large pore zeolites have a framework structure consisting of 12 membered rings with a pore size of about 0.65 to about 0.75 nm. Hydrophobic zeolites generally have Si/Al ratios greater than or equal to about 5 and the hydrophobicity generally increases with increasing Si/Al ratios. The most preferred zeolites have a Si/Al ratio of at least about 25.

Zeolites with a high Si/Al ratio can be prepared synthetically or by modification of high alumina-containing zeolites using methods well known in the art. These methods include, but are not limited to, treatment with SiCl₄ or (NH₄)₂SiF₆ to replace Al with Si, as well as steaming followed by acid treatment. A SiCl₄ treatment is described by Blatter [J. Chem. Ed. 67: 519 (1990)]. An (NH₄)₂SiF₆ treatment is described by Breck in U.S. Pat. No. 4,503,023. These treatments are generally very effective at increasing the Si/Al ratio for zeolites such as zeolites Y and mordenite. In addition, Cooper (WO 00/51940) describes a method for preparing a zeolite with a high Si/Al ratio by calcining a zeolite in steam under turbulent conditions with respect to the flow pattern of the zeolite at a temperature between 650-1000° C. The presence of aluminum atoms in the frameworks results in hydrophilic sites. On removal of these framework aluminum atoms, water adsorption is seen to decrease and the material becomes more hydrophobic and generally more organophilic. See for example the discussion of hydrophobicity in zeolites by Chen [J. Phys. Chem. 80: 60 (1976)]. It is also possible to make any zeolite hydrophobic by treating it with a hydrophobic reagent such as an organosilane.

Additionally, certain types of molecular sieves, of which zeolites are a sub-type, may be used as the adsorbent in the present invention. Molecular sieves are well known in the art and are described by Szostak [Molecular Sieves Principles of Synthesis and Identification, Van Nostrand Reinhold, N.Y., 1989)]. While zeolites are aluminosilicates, molecular sieves contain other elements in place of aluminum and silicon, but have analogous structures. Large pore, hydrophobic molecular sieves that have similar properties to the preferred zeolites described above are suitable for use herein. Examples of such molecular sieves include, but are not limited to, Ti-Beta, B-Beta, and Ga-Beta silicates.

Following the contacting of the aqueous mixture with the zeolite or molecular sieve adsorbent, the adsorbent is separated from the aqueous mixture. When the zeolite or molecular sieve is used in a batch reactor, this separation can be accomplished by means such as filtration or centrifugation. When the zeolite or molecular sieve adsorbent is used in a column, separation may be performed by passing the aqueous mixture through the column. Then, the zeolite or molecular sieve adsorbent may be washed with water to remove non-adsorbed, soluble components. This step is optional, but is preferred to obtain the highest level of purity of the isoflavones. Separation of the zeolite or molecular sieve adsorbent from the wash solution may be accomplished as described above.

Next, the isoflavones are released by contacting the zeolite or molecular sieve with a suitable organic solvent. Suitable organic solvents include, but are not limited to, alcohols such as ethanol, methanol, and isopropanol. The preferred organic solvent is anhydrous ethanol. The isoflavones are recovered by evaporating the solvent, after separation from the zeolite or molecular sieve, as described above. Optionally, the zeolite or molecular sieve can be regenerated for reuse by repeating the calcination process. However, regeneration of the zeolite or molecular sieve by calcination is not required for reuse.

Methods and materials for use in recovering isoflavones from aqueous mixtures are also set forth in U.S. Application No. ______ (Assigne's Docket No. CL-2082), which is assigned to E. I. du Pont de Nemours and Company and is filed on the same day as this application, and which is incorporated in its entirety as a part hereof for all purposes.

The present invention is further defined in the following examples. These examples, while indicating the preferred embodiments of the invention, are given by way of illustration only. From the above discussion and these examples, one skilled in the art can ascertain the essential characteristics of this invention, and without departing from the spirit and scope thereof, can make various changes and modifications of the invention to adapt it to various uses and conditions.

### General Methods

### Sample Preparation

Samples No. 1-12

The zeolite samples listed in Table 1 were calcined in air by heating 1° C./minute to 400° C., holding for 10 minutes at 400° C., heating 1° C./minute to 450° C., holding for 10 minutes at 450° C., heating 1° C./minute to 500° C., holding for 5 hours at 500° C., and then cooling to 110° C. The samples were transferred rapidly to dry jars, which were then closed and sealed.

TABLE 1
List of zeolite samples used and their source

| | | | Zeolite | | | |
|---|---|---|---|---|---|---|
| Sample | Vendor | Product Name | (Calcined) | Si/Al | Form | Lot Number |
| 1 | Zeolyst¹ | CBV-901 | H-SDUSY | 40 | Powder | 1822-66 |
| 2 | Zeolyst¹ | ZD2K014 | H-SDUSY | 40 | Extrudates | 001-124 |
| 3 | Zeolyst¹ | CBV-90A | H-Mordenite | 45 | Powder | 1822-60-30 |
| 4 | Zeolyst¹ | ZD 96065 | H-Mordenite | 15 | Powder | 1822-41 |
| 5 | Zeolyst¹ | CP 811C-300 | H-Beta | 150 | Powder | 1822-85 |
| 6 | Zeolyst¹ | CP 811E-150 | H-Beta | 75 | Powder | 1822-75 |
| 7 | Degussa² | DAY-55 | DA-Y | 55 | Powder | TC133 |
| 8 | UOP³ | HI-SIV 4000 | unknown | Unknown | Powder | 976594061003 |
| 9 | Alfa⁴ | LZ-Y52 | Na-Y | 2.5 | Powder | 030784 |
| 10 | Aldrich⁵ | 13X | Na-X | 1.25 | Powder | 01820CY |
| 11 | Union | S-115 | | | Powder | 11736-19 |
| | Carbide⁶ | | Silicalite | 90-200 | | |
| 12 | Union | AIPO₄-5 | AIPO₄-5 | — | Powder | 13551-91-25C |
| | Carbide | | | | | |

¹Valley Forge, PA
²South Plainfield, NJ
³Des Plaines, IL
⁴Ward Hill, MA
⁵Milwaukee, WI
⁶New York,

Sample 13 Poly(styrene-co-divinylbenzene)(PS-DVB).

Commercial macromolecular adsorbent poly(styrene-co-divinylbenzene) (PS-DVB) (300-800 um) was secured from Aldrich Chemical Company (Catalog ID 41,910-9), Milwaukee, Wis. The sample was rinsed with at least 10 volumes of deionized water and stored under water prior to use. The sample was weighed wet and the equivalent dry weight was determined at the end of the experiment by oven-drying a selected wet weight.

Sample 14 A Specially Synthesized Polymeric Adsorbent Prepared by Suspension Polymerization of Methacrylic Acid, Styrene, and Ethylene Glycol Dimethacrylate

This sample refers to a specially synthesized polymeric adsorbent (SPA) prepared by suspension polymerization of methacrylic acid, styrene and ethylene glycol dimethacrylate in the molar ratio of 9:9:83 using ethyl acetate (EtOAc) as solvent. To prepare the polymer, excess quantities of solvent and deionized water were deoxygenated for 30 min by sparging with nitrogen. The aqueous phase was prepared by stirring the water-soluble ingredients into the designated amount of sparged water under nitrogen in a round-bottom flask. A 3-neck, round-bottom reaction flask (250- or 500-mL as appropriate) was assembled with a reflux condenser, mechanical stirrer (glass rod), and thermocouple-in-well; the condenser was connected to a trap and nitrogen bubbler to maintain a slight positive pressure. When the aqueous phase components were almost completely dissolved in their round-bottom flask, the charging of the separate, 3-neck, reaction flask was begun. While flushing it with nitrogen, the flask was charged with solvent and then the monomers were transferred by syringe. The azo initiator (Vazo® 67) was added (0.2 g) by very briefly removing the thermocouple (TC) well to introduce the powder while maintaining a slight nitrogen flush. The ingredients were carefully and briefly mixed behind a shield and a drawn hood sash. The aqueous phase was added while maintaining a nitrogen flush through the flask. The mixture was stirred well and then, with the TC well removed, briefly deoxygenated again with nitrogen. Then the TC well was reinserted into the 3rd neck of the flask. With stirring at 600 rpm, the solution was brought to the desired temperature, 70° C., in a ˜80° C. oil bath equipped with a TC-controlled heater and over-temperature controller. The time when the flask approached the desired reaction temperature was noted as ‘time 0’. The reaction was run for 6 h, with stirring. The desired conversion of small monomers was ˜90% or higher. Polymerization was terminated by opening the system to air, adding 0.1 g p-methoxyphenol (MEHQ) in 10 mL EtOAc, and removing the heat source. The mixture was stirred while cooling.

The polymer beads were filtered on a coarse filter and washed 3 times, each with 50 mL of deionized water. During all filtrations, vacuum was temporarily shut off when water was added, water was well mixed with the beads, and then vacuum was turned on again to remove the water. The polymer was dried in the fume hood overnight and then in a 65° C. vacuum oven with vacuum and slight nitrogen bleed. The polymer was stored in an airtight vial and used as is.

Sample 15H-Beta (Si/AI=75).

A 10 g sample of H-Beta (Si/AI=75) (CP 811E-150, Lot No. 1822-75, Zeolyst, Valley Forge, Pa.) was calcined in air by heating 1° C./minutes to 450° C., holding for 10 minutes at 450° C., heating 1° C./minute to 500° C., holding for 10 minutes at 500° C., heating 1° C./minute to 550° C., holding for 5 hours at 550° C., and then cooling to 110° C. The sample was transferred rapidly to a dry jar, which was then closed and sealed.

Samples 16-20.

The zeolite samples listed in Table 2 were calcined in air by heating 1° C./minute to 400° C., holding for 10 minutes at 400° C., heating 1° C./minute to 450° C., holding for 10 minutes at 450° C., heating 1° C./minute to 500° C., holding for 5 hours at 500° C., and then cooling to 110° C. The samples were transferred rapidly to dry jars, which were then closed and sealed.

TABLE 2
List of beta zeolite samples and their source

| | | Product | | | | |
|---|---|---|---|---|---|---|
| Sample | Vendor | Name | Zeolite | Si/Al | Form | Lot Number |
| 16 | Zeolyst¹ | CP 814E CY | H-Beta | 12.5 | Extrudates | 1994-3 |
| | | | | | (20% Al₂O₃) | |
| 17 | Zeolyst¹ | CP 811C- | H-Beta | 150 | Extrudates | 2112-7 |
| | | 300 CY | | | (20% Al₂O₃) | |
| 18 | Zeolyst¹ | CP 811E-150 | H-Beta | 75 | Powder | 1822-75 |
| 19 | Zeolyst¹ | CP 811C- | H-Beta | 150 | Powder | 1822-19 |
| | | 300 | | | | |
| 20 | Zeolyst¹ | CP 814E | H-Beta | 12.5 | Powder | 1822-52 |

¹Valley Forge, PA

Batch Experiments:

Soy whey samples were obtained from DuPont Protein Technologies (St. Louis, Mo.) in the form of soy molasses, consisting of 55% solids. The soy molasses was diluted by mixing one part molasses with 9 parts of deionized water and this mixture was allowed to equilibrate for 90 min. The mixture was then centrifuged at 9000 rpm for 30 min at room temperature. The supernatant from the centrifugation step was used as the soy whey concentrate. The soy whey concentrate was ultra-filtered through a 10 kDA hollow fiber module (UFP-10-E-4A, obtained from A/G Technology Corporation, Needham, Mass.) in batch mode. The soy whey concentrate was pumped and recirculated through the lumen of the hollow fibers in the cartridge using a Masterflex® pump (Cole-Parmer Instruments, Vernon Hills, Ill.). The flow rate of the soy whey concentrate varied from 1 to 5 mL/min. The soy whey permeate from the filter module was collected and either used immediately or was refrigerated or frozen in small batches for future use. Typically, 400-600 mL of soy whey permeate was collected from the ultra-filtration process over a 4 h interval from 1 L of initial soy whey concentrate.

A known mass of the dry zeolite sample (typically 0.2-5 g) was contacted with a known volume of soy whey (typically 2.5-50 mL). Samples were placed on a laboratory rotary shaker (typically set at 200 rpm) and shaken at room temperature for 4-24 h. A portion of the supernatant (typically 1 mL) was withdrawn, filtered, and assayed for isoflavones by high performance liquid chromatography (HPLC) analysis as described below.

For desorption experiments, zeolites were saturated with whey by contacting a small sample (typically 1-5 g) with a large volume of whey (typically 1-5 L). The whey was filtered away from the solution and the zeolite samples were contacted again with another large volume of whey. A sample of the whey was tested using HPLC to monitor the change in isoflavone concentration. The process was repeated with no intermediate rinses until no change in the solution concentration was detectable. The zeolite was then regenerated by repeatedly washing with aliquots of anhydrous ethanol (100-500 mL). These rinses were analyzed for isoflavones concentration using HPLC.

Quantitation of Isoflavones using HPLC:

Isoflavones were resolved and quantified at 260 nm using HPLC on a 2.1 mm×100 mm Hypersil ODS column (3 micron stationary phase). Mobile phase A (88:10:2) of water:methanol:glacial acetic acid and Mobile phase B consisted of 98:2 methanol:glacial acetic acid. A flow rate of 0.2 ml/min was used with a gradient varying from 95% A at t=0 min, 30% A at t=1 min, 0% A at t=16 min, and 95% A at t=19.5 min and remaining time until the end of the 27.5 minute run. Other details of the HPLC procedure are as typically run in the art. The difference in isoflavone concentration in the soy whey before and after the experiment was used to estimate the weight of isoflavones adsorbed on the samples. Any negative values in the results presented in the following tables should be interpreted as being equal to zero within the experimental error of the measurement.

Quantitation of Sugars using Ion Chromatographv (IC):

Sugar concentrations were determined using a Dionex DX500 IC equipped with a CarboPac PA10 column. The chromatography was carried out at 35° C. using a mobile phase consisting of NaOH (27% of a 200 mM solution) and deionized water (73%) at a flow rate of mL/min. The sugars (glucose, sucrose, fructose, raffinose and stachyose) were detected using an ED Amperometer. The sugars were identified and quantified by comparison to authentic standards. Any negative values in the results presented in the following tables should be interpreted as being equal to zero within the experimental error of the measurement.

Adsorption Measurements:

For isoflavone adsorption from soy whey, the adsorption data was converted to an aglycone basis as follows: aglycone mass adsorbed=mass of daidzein adsorbed+mass of glycitein adsorbed+mass of genistein adsorbed+mass of daidzin adsorbed×(MW daidzein/MW daidzin)+mass of glycitin adsorbed×(MW glycitein/MW glycitin)+mass of genistin adsorbed×(MW genistein/MW genistin). The isoflavone loading (mass isoflavone/mass zeolite) was calculated by taking the concentration difference times the solution volume and dividing by the mass of dry zeolite used in the experiment. The adsorption isotherms for the uptake of isoflavones from soy whey on the zeolite samples at room temperature were obtained by plotting the isoflavone loading, in mg/g dry weight of zeolite, versus the equilibrium concentration of the isoflavones, in mg/mL.

### EXAMPLE 1

### Preferential Binding of Isoflavones on Specific Zeolites

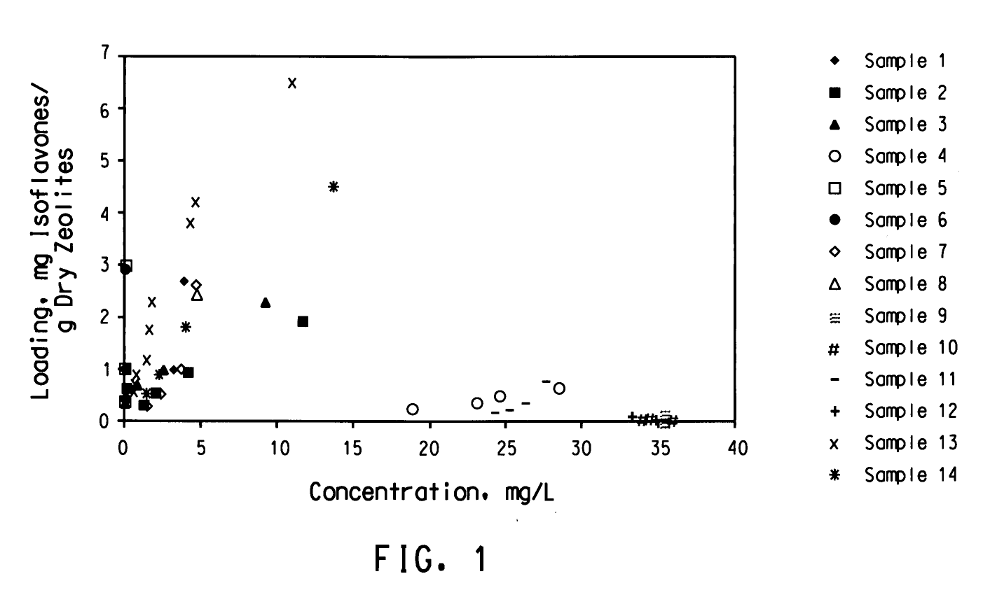

A variety of zeolites were tested for uptake of isoflavones from dilute soy whey using the batch adsorption experiments described earlier. FIG. 1 shows the adsorption isotherms for these materials. The raw data for this graph is given in Table 3.

The value for the constants K and n for each sample was estimated from a linear regression fit to the standard Power law equation for an adsorption isotherm, i.e. q=KCⁿ where q is the isoflavone loading on the zeolite, and C is the equilibrium isoflavone concentration. R in the table refers to the correlation coefficient for the regression fit. The resulting values are given in Table 4.

TABLE 3
Raw Data for the Adsorption of Isoflavones onto Various Zeolites

| Sample ID | Sample | Concentration, mg/L | Loading, mg/g |
|---|---|---|---|
| Sample 1 | CBV-901 | 3.86 | 2.72 |
| | | 2.41 | 0.98 |
| | | 1.50 | 0.53 |
| | | 0.79 | 0.27 |
| Sample 2 | ZD2K014 | 11.95 | 1.96 |
| | | 3.36 | 0.95 |
| | | 1.57 | 0.49 |
| | | 0.95 | 0.27 |
| Sample 3 | CBV-90A | 8.81 | 2.31 |
| | | 1.48 | 0.99 |
| | | 0.56 | 0.55 |
| | | 0.27 | 0.28 |
| Sample 4 | ZD96065 | 27.75 | 0.54 |
| | | 24.66 | 0.30 |
| | | 22.72 | 0.18 |
| | | 18.67 | 0.13 |
| Sample 5 | CP-811C-300 | 0.00 | 2.96 |
| | | 0.00 | 1.06 |
| | | 0.00 | 0.56 |
| | | 0.00 | 0.28 |
| Sample 6 | CP811E-150 | 0.00 | 2.89 |
| | | 0.00 | 1.09 |
| | | 0.00 | 0.55 |
| | | 0.00 | 0.29 |
| Sample 7 | DAY-55 | 4.66 | 2.53 |
| | | 3.09 | 0.98 |
| | | 1.75 | 0.45 |
| | | 1.12 | 0.27 |
| Sample 8 | HI-SIV 4000 | 4.65 | 2.39 |
| | | 1.60 | 1.00 |
| | | 0.68 | 0.49 |
| | | 0.27 | 0.27 |
| Sample 9 | LZ-Y52 | 35.60 | −0.13 |
| | | 35.80 | −0.05 |
| | | 34.24 | 0.00 |
| | | 35.62 | −0.01 |
| Sample 10 | 13X | 34.00 | 0.01 |
| | | 34.64 | −0.02 |
| | | 36.02 | −0.03 |
| | | 34.14 | 0.00 |
| Sample 11 | S-115 | 26.92 | 0.59 |
| | | 25.87 | 0.25 |
| | | 25.16 | 0.15 |
| | | 24.21 | 0.08 |
| Sample 12 | AIPO₄-5 | 34.78 | −0.05 |
| | | 35.32 | −0.04 |
| | | 34.73 | −0.01 |
| | | 33.85 | 0.00 |
| Sample 13 | PS-DVB | 0.44 | 0.88 |
| | | 0.48 | 0.73 |
| | | 1.11 | 1.16 |
| | | 1.24 | 1.72 |
| | | 1.65 | 2.26 |
| | | 4.36 | 3.74 |
| | | 4.77 | 4.16 |
| | | 10.95 | 6.47 |
| Sample 14 | SPA | 0.92 | 0.49 |
| | | 1.76 | 0.95 |
| | | 3.88 | 1.8 |
| | | 13.82 | 4.59 |

TABLE 4
Results of fitting data to the Power Law equation

| | | | |
|---|---|---|---|
| SAMPLE | K | n | R² |

| | | | | |
|---|---|---|---|---|
| 1. | CBV-901 | 0.34 | 1.42 | 0.97 |
| 2. | ZD2K014 | 0.32 | 0.76 | 0.97 |
| 3. | CBV-90A | 0.70 | 0.59 | 0.98 |
| 4. | ZD96065 | 0.00 | 3.61 | 0.92 |
| 5. | CP 811C-300 | INF | 1.00 | 1.00 |
| 6. | CP811E-150 | INF | 1.00 | 1.00 |
| 7. | DAY-55 | 0.20 | 1.54 | 0.98 |
| 8. | HI-SIV 4000 | 0.71 | 0.77 | 1.00 |
| 9. | LZ-Y52 | 0.00 | 1.00 | 1.00 |
| 10. | 13X | 0.00 | 1.00 | 1.00 |
| 11. | S-115 | 0.00 | 18.62 | 0.99 |
| 12. | AIPO₄-5 | 0.00 | 1.00 | 1.00 |
| 13. | PS-DVB | 1.36 | 0.68 | 0.97 |
| 14. | SPA | 0.56 | 0.82 | 1.00 |

This screening protocol identified several zeolites that had an affinity for isoflavones present in soy whey. Particularly notable were sample 1 (CBV 901/NaY), sample 8 (HI-SIV 4000), sample 2 (ZD2VK014), sample 3 (CBV-90A), sample 5 (H-beta 150), and sample 6 (H-beta 75). These samples are large pore, hydrophobic zeolites. The beta zeolites, samples 5 and 6, had the highest affinity for isoflavones.

### EXAMPLE 2

### Comparative Example of the Adsorption of Isoflavones by Organic Polymer Supports

Two organic polymer supports, i.e., PS-DVB (Sample 13) and a specially synthesized polymeric adsorbent (Sample 14), were tested for isoflavone adsorption as described in Example 1. The raw data obtained for these polymers is included in Table 3 and the adsorption isotherms are shown in FIG. 1. The results of the fit to the Power equation are given in Table 4. As can be seen from FIG. 1, both of these organic polymers had a significantly lower affinity for isoflavones than the beta zeolite samples.

### EXAMPLE 3

### Binding Characteristics of Isoflavones to Beta Zeolites in the Presence of Oligosaccharides

Batch adsorption experiments with the beta zeolites listed in Table 5 were used to determine the equilibrium isotherms at room temperature. The parameters Qmax and B for a Langmuir fit (q=Qmax B C/(1+B C)) to the adsorption equilibrium were estimated using regression analysis. Here q is the loading on the solid phase in mg/g of dry solid, and C is the concentration in the fluid phase at equilibrium in mg/L. Qmax and B are empirical constants. Qmax is an approximate estimate of the monolayer binding capacity on the zeolite. An approximate binding capacity of 14-20 mg isoflavones/g zeolite, on an aglycone basis, was estimated. The parameters for a set of free flowing Beta zeolite powders with varying Si/Al ratios and the equivalent pellet samples with 20% Alumina binder are summarized in Table 5.

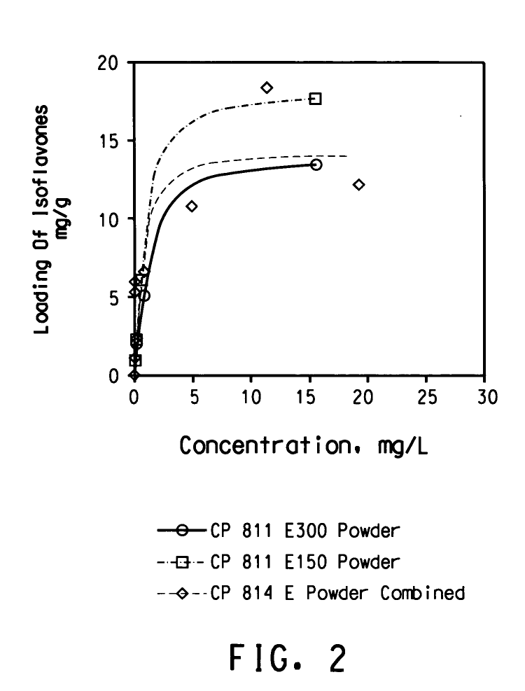

As shown in Table 5 and in FIG. 2, the binding isotherms are only a weak function of the Si/Al ratio of beta zeolites. The raw data for FIG. 2 are given in Table 6. In FIG. 2, the lines represent least square fits of the data to a Langmuir adsorption equation.

TABLE 5
Summary of the estimated Langmuir parameters for beta zeolites.

| Sample | | Si/Al | | K (q/c at | | |
|---|---|---|---|---|---|---|
| No. | Sample Name | ratio | Form | C = 0) | Q max | R² value |
| 16 | CP 814 E CY 20% | 12.5 | pellets* | 0.2402 | — | 0.9785 |
| | alumina | | | | | |
| 17 | CP 811 C 300 CY | 150 | pellets* | 0.1636 | — | 0.9726 |
| | 20% alumina | | | | | |
| 18 | CP 811 E 150 | 75 | powder | 18.2853 | 19.165 | 0.9973 |
| 19 | CP 811 C-300 | 150 | powder | 1.6438 | 13.977 | 0.9965 |
| 20 | CP 814 E powder | 12.5 | powder | 27.0807 | 14.253 | 0.8976 |

*Here pellets refer to 1.6 mm extrudates of zeolite powder with specified percentage of binder.

TABLE 6
Raw data for isotherms shown in FIG. 2

| Sample Name | Concentration, mg/L | Loading, mg/g |
|---|---|---|
| 19. CP 811 C 300 | 0.00 | 0.89 |
| | 0.00 | 0.30 |
| | 0..49 | 5.11 |
| | 15.5 | 13.2 |
| 18. CP 811 E 150 | 0.00 | 1.12 |
| | 0.00 | 0.34 |
| | 0.50 | 6.19 |
| | 15.4 | 17.9 |
| 20. CP 814 E powder | 0.0 | 0.87 |
| | 0.0 | 0.26 |
| | 0.11 | 5.36 |
| | 14.1 | 13.02 |
| | 0.00 | 1.12 |
| | 0.00 | 0.35 |
| | 0.00 | 6.03 |
| | 11.38 | 18.48 |
| | 0.63 | 6.30 |
| | 5.16 | 10.76 |
| | 19.04 | 12.16 |

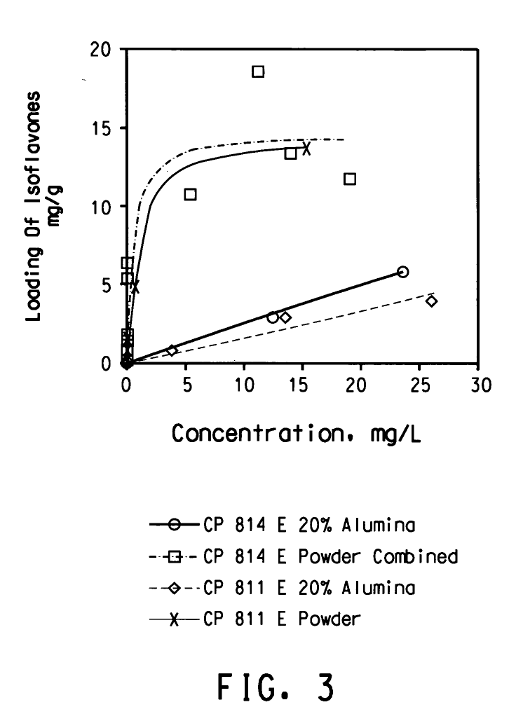

Also, as shown in Table 5 and FIG. 3, zeolite powders when compounded with a binder and pelletized, showed a significantly lower capacity and affinity for the isoflavones than would be accounted by simple proportional dilution of the powder sample. For example, as shown in FIG. 3, with a 20% alumina binder, the isotherms significantly deviate from their “nearly rectangular” shape to a more linear form with a lower partition coefficient between the support phase and soy whey. The raw data for FIG. 3 is given in Table 7. In FIG. 3, the lines represent least square fits of the data to a Langmuir adsorption equation.

TABLE 7
Raw data for the isotherms in FIG. 3.

| Sample Name | Concentration, mg/L | Loading, mg/g |
|---|---|---|
| 16. CP 814 E CY | 0.00 | 0.94 |
| 20% alumina | 0.00 | 0.29 |
| | 12.44 | 2.89 |
| | 23.81 | 5.77 |
| 20. CP 814 E powder | 0.00 | 0.87 |
| combined | 0.00 | 0.26 |
| | 0.11 | 5.36 |
| | 14.06 | 13.02 |
| | 0.00 | 1.12 |
| | 0.00 | 0.35 |
| | 0.00 | 6.03 |
| | 11.38 | 18.48 |
| | 0.63 | 6.30 |
| | 5.16 | 10.76 |
| | 19.04 | 12.16 |
| 17. CP 811 C 300 CY | 3.63 | 0.78 |
| 20% alumina | 0.00 | 0.29 |
| | 13.32 | 2.82 |
| | 26.4 | 3.97 |
| 19. CP 811 C 300 | 0.00 | 0.89 |
| powder | 0.00 | 0.30 |
| | 0.49 | 5.11 |
| | 15.5 | 13.25 |

### EXAMPLE 4

### Absence of Adsorption of Oligosaccharides such as Raffinose and Stachyose onto Beta Zeolites

Adsorption of sugars, including the oligosaccharides raffinose and stachyose, to beta zeolite (Sample 18, CP 811 E 150) was tested by contacting varying amounts of the zeolite with a fixed volume (2.5 mL) of soy whey. The final concentration of each sugar in solution was determined using ion chromatography and the estimated amount adsorbed onto the zeolite is shown in Table 8. In each case at equilibrium, the amount of the sugar on the zeolite surface is less than 1% of the corresponding solution concentration, indicating that there is negligible adsorption of the sugars to the beta zeolite.

TABLE 8
Adsorption of Sugars onto beta zeolite (Sample 18)

| | Solution | | (Adsorbed/ |
|---|---|---|---|
| | Concentration, | Adsorbed | Concentration) |
| Compound | ppm | ppm | % |
| Glucose | 2480 | −4.8 | −0.2 |
| Glucose | 1897 | 7.5 | 0.4 |
| Glucose | 1546 | 7.1 | 0.5 |
| Glucose | 1761 | 3.0 | 0.2 |
| Sucrose | 962 | 0.3 | 0.0 |
| Sucrose | 716 | 4.0 | 0.6 |
| Sucrose | 554 | 3.5 | 0.6 |
| Sucrose | 676 | 1.4 | 0.2 |
| Raffinose | 706 | −3.4 | −0.5 |
| Raffinose | 491 | 2.2 | 0.4 |
| Raffinose | 379 | 2.2 | 0.6 |
| Raffinose | 450 | 0.9 | 0.2 |
| Stachyose | 3110 | −21.0 | −0.7 |
| Stachyose | 2190 | 7.2 | 0.3 |
| Stachyose | 1674 | 8.3 | 0.5 |
| Stachyose | 2006 | 3.1 | 0.2 |

As shown in FIG. 1, a preferred zeolite in this invention, zeolite beta, has a significantly higher affinity for isoflavones than either the conventional poly(styrene-co-divinylbenzene) (PS-DVB) adsorbent, or the specifically synthesized polymeric adsorbent prepared by suspension polymerization of methacrylic acid, styrene, and ethylene glycol dimethacrylate. Moreover, zeolite beta was found to have essentially no adsorption of oligosaccharides, including the undesired oligosaccharides raffinose and stachyose, as shown in Example 4.

### EXAMPLE 5

### Recovery of Isoflavones from Loaded Beta Zeolites Using Anhydrous Ethanol as an Eluant

A sample of zeolite Beta pellets (Sample 17, CP 811 C 300 CY 20% alumina, 1-5 g) was loaded with isoflavones such that the zeolite was in equilibrium with the isoflavones in the soy whey. This was accomplished by repeatedly contacting the zeolite sample with a large volume of diluted soy whey (1-10 L). When there was little change in the concentration of the contacted whey, the sample was assumed to have reached a saturation loading. This sample was then filtered out from the whey and contacted with a measured volume (100-500 mL) of anhydrous ethanol. A sample (typically 1 mL) of ethanol was analyzed for isoflavones using HPLC. The process was repeated until there was no isoflavone recovered off the zeolite. The isoflavones were eluted with the ethanol fraction. The ethanol was then evaporated to recover a concentrated sample of the isoflavones. The fractional recovery (%) of isoflavones ranged from 37% to 61% (ratio of isoflavones recovered in ethanol fraction to that estimated to be bound to the zeolite from the decrease in concentration during the loading, expressed as a percentage)

1. A method for selectively recovering isoflavones from an aqueous mixture comprising the steps of:
(a) contacting a large pore, hydrophobic zeolite or molecular sieve with an aqueous mixture containing isoflavones;
(b) separating the zeolite or molecular sieve from the aqueous mixture; and
(c) contacting the zeolite or molecular sieve with an organic solvent to release adsorbed isoflavones

2. A method of using a large pore, hydrophobic zeolite or molecular sieve for selectively recovering isoflavones from an aqueous mixture comprising the steps of:
(a) contacting a large pore, hydrophobic zeolite or molecular sieve with an aqueous mixture containing isoflavones;
(b) separating the zeolite or molecular sieve from the aqueous mixture; and
(c) contacting the zeolite or molecular sieve with an organic solvent to release adsorbed isoflavones.

3. The method of claim 1 or 2 wherein the aqueous mixture is a biological waste product.

4. The method of claim 3 wherein the biological waste product is soy whey.

5. The method of claim 1 or 2 wherein the zeolite is zeolite beta.

6. The method of claim 1 or 2 wherein the organic solvent is an alcohol.

7. The method of claim 1 or 2 wherein the organic solvent is methanol, ethanol, or isopropanol.

8. The method of claim 1 or 2 wherein the organic solvent is ethanol.

9. The method of claim 1 or 2 wherein the zeolite or molecular sieve is contacted with the aqueous mixture in a batch reactor.

10. The method of claim 1 or 2 wherein the zeolite or molecular sieve is contacted with the aqueous mixture in a column.

11. The method of claim 1 or 2 wherein steps (a) and (b) are repeated one or more times.

12. The method of claim 1 or 2 wherein the zeolite or molecular sieve is washed with water after step (b).
